(19) United States
(12) Patent Application Publication
(10) Pub. No.: US 2003/0197579 A1
(43) Pub. Date: Oct. 23, 2003

(54) High-frequency filter

(75) Inventors: Koyo Kegasa, Kobe-shi (JP); Chitaka Manabe, Kobe-shi (JP)

Correspondence Address: REED SMITH HAZEL & THOMAS LLP, P.O. Box 12001, Falls Church, VA, 22042-4503, US

(73) Assignee: Kabushiki Kaisha Kobe Seiko Sho.

(21) Appl. No.: 10/417,164

(22) Filed: Apr. 17, 2003

(30) Foreign Application Priority Data
Apr. 19, 2002 (JP) 2002-117720

(51) Int. Cl. H01P 7/10

(52) U.S. Cl. 333/202; 333/219.1

(57) ABSTRACT

A high-frequency filter using a dielectric resonator includes an insulating substrate on which an input linear conductor and an output linear conductor are formed in parallel to each other, and a dielectric resonator which is coupled to the substrate. The dielectric resonator is arranged so that the direction of the center magnetic field of the dielectric resonator becomes approximately parallel to the substrate and becomes approximately at right angles to the linear conductors. With such an arrangement, a high-frequency filter, in which fine adjustment of a coupling factor and a resonance frequency is easy while maintaining Q of the dielectric resonator to be high, whose size can be reduced, and which can be mounted inexpensively is provided.

### BACKGROUND OF THE INVENTION

1. Field of the Invention

The present invention relates to high-frequency filters used in wireless communication apparatuses and wired communication apparatuses.

2. Description of the Related Art

In high-frequency filters for use in a communication system in which a high-frequency radio wave of 300 MHz (Megahertz) or higher is used as a carrier, as resonator-type filters, dielectric-resonator filters in addition to strip-line resonators are used. The dielectric resonator itself used in this dielectric-resonator filter has a suitable shape, such as a cylindrical shape, a circular pillar shape, or a disc shape, of a dielectric material having a high dielectric constant. For example, FIG. 8 shows a cylindrical dielectric resonator. In the case of such a dielectric resonator 1, when an electric field 3 corresponding to a resonance frequency fc is applied, since this electric field 3 flows in a doughnut pattern or in a ring pattern in the circumferential direction inside the cylinder of the dielectric resonator 1, a high-frequency magnetic field indicated by “2” occurs regardless of the above shape. The high-frequency magnetic field 2 exits perpendicularly with respect to a top circular surface 1a from the top circular surface 1a of the cylinder of the dielectric resonator 1, circles around the cylinder, and returns to a bottom circular surface 1b of the cylinder. At this time, a center magnetic field 2a of the dielectric resonator 1 exits from the center of the top circular surface 1a and enters the center of the bottom circular surface 1b. The magnitude of the magnetic field of this dielectric resonator 1 is determined by the size of the dielectric resonator 1 and the dielectric constant of the dielectric material forming the resonator.

By using the magnetic field of such a dielectric resonator, for example, only specific wavelength components to be passed, of the high-frequency wave which passes through a high-frequency transmission line, such as a microstrip line, can be passed without being attenuated, whereas wavelength components of other than the specific wavelength (resonance frequency) can be attenuated so as to be eliminated.

Here, the term “microstrip line” refers to the name of a distributed capacity line of a configuration in which, as shown in FIG. 9, an elongated high-frequency transmission strip line (hereinafter referred to as a “high-frequency strip line”) 5, which is a conductor of a metal such as copper, is provided on the surface 4a of a substrate 4 formed of a dielectric, such as a printed substrate or a ceramic substrate, and a grounding conductor is arranged on a rear surface 4b of the substrate.

However, when such a dielectric resonator is directly mounted on the surface of the microstrip line (substrate), an electromotive force is generated on the surface of the substrate as a result of being induced by the high-frequency magnetic field of the dielectric resonator, and electrical current flows on the surface of the substrate. The high-frequency magnetic field on the substrate side, which occurs due to this electrical current, is generated in a direction in which the high-frequency magnetic field of the dielectric resonator is cancelled.

As a result, the high-frequency magnetic field can only penetrate into a very shallow (thin) area of the surface of the substrate. This phenomenon is called a “skin effect”, and the above-described electrical current which flows on the surface of the substrate is called a “skin current”. Due to this skin effect, the high-frequency magnetic field 2 of the dielectric resonator can penetrate only up to a very shallow (thin) area of the surface of the substrate. For this reason, due to the skin effect, the high-frequency magnetic field of the dielectric resonator is made to repel by the grounding conductor on the rear surface of the substrate, and is greatly distorted, as shown in FIG. 9.

More specifically, as shown in FIG. 9, although the high-frequency magnetic field 2 of the dielectric resonator 1 exits from the top circular surface 1a of the cylinder of the dielectric resonator 1, since the high-frequency magnetic field 2 must pass through the space between the bottom circular surface 1b of the cylinder and the grounding conductor (not shown) of the rear surface 4b of the substrate 4 and return to the bottom circular surface 1b, the high-frequency magnetic field 2 is greatly distorted. For this reason, since an induced current in a direction in which the high-frequency magnetic field 2 is cancelled flows in the grounding conductor in proximity to the high-frequency magnetic field 2, the high-frequency magnetic field is distorted in such a pattern so as to be blocked by the grounding conductor, the high-frequency magnetic field 2 is drastically weakened, and the resonance frequency fc of the dielectric resonator increases considerably. Furthermore, since the conductor used as a grounding conductor has resistance, conductor loss occurs due to the induced current. This becomes a load for the dielectric resonator, causing the effective Q (effective quality factor, the amount indicating the sharpness of the resonance of the resonance circuit) to be decreased. Since the effective Q is decreased, the function of the high-frequency filter for removing wavelength components of other than a specific wavelength (resonance frequency) by attenuating them is weakened considerably.

Since the electrical conductivity of the grounding conductor and a high-frequency strip line (conductor) 5 is not infinitely large, but has some resistance, loss occurs, in the form of heat loss due to heat generation, in the high-frequency current itself of the grounding conductor and the high-frequency strip line 5. Therefore, as a result of the above, the value of the effective Q, which is an important high-frequency filter characteristic of the dielectric resonator 1, is greatly decreased.

Hitherto, as means for preventing this decrease of the effective Q, generally, insertion of a base made of an insulator such as ceramics between the dielectric resonator and the substrate in various ways has been proposed. For example, in Japanese Unexamined Utility Model Application Publication No. 5-59935, as shown in FIG. 10, insertion of six bases 6 made of an insulator such as ceramics between the cylindrical dielectric resonator 1 and the substrate 4 is proposed. The presence of these bases 6 causes the section between the dielectric resonator 1 and the substrate 4 to be separated by an amount corresponding to the height of the insulator bases 6, and thus the distortion of the high-frequency magnetic field 2 of the dielectric resonator 1 is lessened when compared with the above-described case of FIG. 9. As a result, the variation of the resonance frequency fc of the high-frequency magnetic field 2 is also decreased, and the skin current which is induced in the substrate 4 is also decreased. Consequently, the decrease of the effective Q of the high-frequency filter of the dielectric resonator 1 is lessened.

Unlike the configuration in FIG. 9, a configuration in which the center axis of a dielectric resonator is placed in parallel to the plane on which a microstrip line is provided or to the plane of a flat-plate metal piece for input/output coupling is disclosed in Japanese Unexamined Utility Model Application Publication No. 4-96102, Japanese Unexamined Patent Application Publication No. 62-72203, and Japanese Unexamined Patent Application Publication No. 61-136301. In these configurations, it is considered that distortion of a high-frequency magnetic field such as that shown in FIG. 9 will not occur.

In this type of dielectric resonator, the dielectric resonator 1 functions by being coupled in a magnetic loop with the high-frequency strip line 5 on the substrate 4. For this reason, if this coupling factor (degree of coupling) is too small, the loss of the high-frequency filter of the dielectric resonator 1 increases. On the other hand, if this coupling factor is too great, since input/output loads are connected in parallel to the dielectric resonator 1, the effective Q of the dielectric resonator 1 decreases. Therefore, in this type of dielectric resonator, in order to maintain the effective Q to be high while suppressing the loss of the high-frequency filter, the adjustment of the coupling factor with the conductor such as the high-frequency strip line 5 on the substrate 4 becomes indispensable.

In general, when the effective Q is denoted as Qe, Q during no load (when the dielectric resonator is placed in a vacuum) is denoted as Qu, and Q by coupling with an external circuit is denoted as Q1, the following equation is given:

1/Qe=1/Qu+1/Q1

In the high-frequency wave to be treated by the present invention, since Qu is extremely high, Qe becomes approximately equal to Q1. Then, the relationship also holds such that, when the coupling is made dense (when the coupling factor is increased), Q1 decreases, and conversely, if coupling is made loose (when the coupling factor is decreased), Q1 increases. In this manner, the effective Q is almost determined by only the coupling factor, and the effective Q can be increased by decreasing the coupling factor. In order to decrease phase noise, it is preferable that the configuration be formed so as to increase the effective Q.

On the other hand, if the coupling factor is decreased, the loss in the filter increases. If the loss of the filter increases too much, it does not function, and therefore, the loss needs to be suppressed to a loss in a range in which the filter operates stably. As described above, there is a trade-off relationship between the suppression of phase noise to be small and the stabilization of the filter operation, and the coupling factor must be adjusted to a level in which the above two are permitted. Therefore, in a high-frequency filter using this type of dielectric resonator, the adjustment of the coupling factor is very important. For this reason, there has been a demand for a high-frequency filter having a configuration capable of simply and effectively adjusting the coupling factor.

In the method in which a base made of an insulator such as ceramics is inserted between the dielectric resonator and the substrate, disclosed in the above Japanese Unexamined Utility Model Application Publication No. 5-59935, etc., it is necessary to adjust the coupling factor at the height h of the insulator base 6 of FIG. 10.

However, during the actual adjustment of the coupling factor, when the height of this insulator base 6 is decreased, it is necessary to cut out the insulator base 6 or to replace the insulator base 6 with another insulator base. On the other hand, when the height of this insulator base 6 is increased, there occurs a need to replace the insulator base 6 with another insulator base. These adjustments of the coupling factor are, in practice, very complicated irrespective of cutting out the insulator base 6 or replacing the insulator base 6, requires a large number of adjustment steps and a large part cost, and are not practical at all.

In Japanese Unexamined Utility Model Application Publication No. 4-96102, a configuration in which a dielectric resonator is provided just above one microstrip line is disclosed. However, only the mounting construction of the dielectric resonator is disclosed, and no disclosure has been made on how the high-frequency filter is realized on the assumption of such a positional relationship. Furthermore, since the dielectric resonator is screwed, an additional jig becomes necessary for the purpose of mounting, and fine adjustment of the coupling factor is difficult.

In Japanese Unexamined Patent Application Publication No. 62-72203, a configuration in which a dielectric resonator is provided in the vicinity of one microstrip line is disclosed. However, no disclosure has been made on how the high-frequency filter is realized on the assumption of such a positional relationship. Although the configuration is such that, by changing the mounting position of the dielectric resonator, the coupling is adjusted, only the distance up to one microstrip line is adjusted by moving the dielectric resonator in a parallel direction. For this reason, the degree of freedom of the adjustment is limited. Furthermore, as regards to the adjustment of the resonance frequency, no disclosure has been made. In addition, since a hole is formed in the substrate, an additional manufacturing step becomes necessary.

In Japanese Unexamined Patent Application Publication No. 61-136301, optimization of the direction of the magnetic field generated in a dielectric resonator and the direction of a metal plate which is coupled with the dielectric resonator are studied. However, when seen as a device, as much as two dielectric resonators are used and the three-dimensional configuration is large-scaled. Moreover, no scheme has been provided on the fine adjustment of the coupling factor. For adjusting the resonance frequency, a screw, which is an additional member, is provided. This further causes the device to be enlarged and complicated.

In the manner described above, in the conventional technology, in a high-frequency filter based on a dielectric resonator, an optimum configuration in which even the adjustment and the cost are taken into consideration has not been studied.

### SUMMARY OF THE INVENTION

The present invention has been made in view of these circumstances. An object of the present invention is to provide a high-frequency filter, in which the fine adjustment of a coupling factor and a resonance frequency is made easy while maintaining the effective Q of the dielectric resonator to be high, whose size can be reduced, and which can be incorporated inexpensively.

To achieve the above-mentioned object, the present invention provides a high-frequency filter comprising: an insulating substrate; a linear input conductor formed on the surface of the insulating substrate; a linear output conductor formed substantially in parallel to the input conductor on the same surface of the input conductor of the insulating substrate; and a dielectric resonator which is coupled to the insulating substrate, the dielectric resonator being provided between the input conductor and the output conductor with respect to a direction perpendicular to the extension direction of the input conductor and the output conductor, wherein the dielectric resonator is arranged so that the direction of the center magnetic field generated in the dielectric resonator when a high-frequency signal is input to the input conductor becomes substantially parallel to the insulating substrate and becomes approximately at right angles to the extension direction of the input conductor and the output conductor.

With such an arrangement, in the present invention, a high-frequency filter which efficiently exhibits a high-frequency filter function and which is capable of performing fine adjustment without requiring a special additional member can be realized while maintaining a high effective Q.

More specifically, in the high-frequency filter of the present invention, the dielectric resonator is arranged so that the direction of the center magnetic field generated in the dielectric resonator coupled to the substrate becomes substantially parallel to the substrate. As a result, the effective Q of the dielectric resonator when it is mounted on the substrate is prevented from being decreased.

In addition, in the high-frequency filter of the present invention, the dielectric resonator is arranged so that the direction of the center magnetic field generated in the dielectric resonator coupled to the substrate becomes approximately at right angles to the extension direction of the input/output conductors (high-frequency strip lines, etc.) on the surface of the insulating substrate. As a result, a high-frequency filter having a high coupling factor can be realized. Here, being approximately at right angles means that, for the purpose of adjusting the coupling factor, the deviation of the direction of the center magnetic field deviates from the direction at right angles to the extension direction of the conductors is permitted. As described above, in the high-frequency filter of the present invention, although the direction of the center magnetic field is basically assumed to be at right angles to the extension direction of the conductors, it is expected that the angle with respect to the extension direction of the conductors when the dielectric resonator is coupled to the substrate is varied as necessary. As a result, fine adjustment of the coupling factor becomes possible and easy.

In the high-frequency filter of the present invention, the dielectric resonator may have a shape selected from a cylindrical shape, a circular pillar shape, a disc shape, a ring shape, and a polygonal prism shape. Therefore, in accordance with the necessary coupling factor and resonance frequency or in consideration of the convenience of manufacture, the optimum shape of the dielectric resonator can be selected.

In the high-frequency filter of the present invention, the dielectric resonator may be provided between the input conductor and the output conductor with respect to a direction perpendicular to the extension direction of the input conductor and the output conductor. That is, it is only necessary that the dielectric resonator is positioned where the necessary coupling factor can be obtained in a space surrounded by the plane which passes through the output conductor end-portion line of the input conductor side and which is perpendicular to the substrate, and the plane which passes through the input conductor end-portion line of the output conductor side and which is perpendicular to the substrate. However, among the above, it is most preferable that the dielectric resonator be directly bonded to the insulating substrate. As a result, a mounting member is not necessary, and various fine adjustments can be easily realized. At this time, by forming flat a portion of the dielectric resonator in contact with the substrate, the bonding between the dielectric resonator and the substrate becomes easy.

In the high-frequency filter of the present invention, a grounding conductor may be arranged on the surface of the insulating substrate, which is opposite to the surface on which the input conductor and the output conductor are provided.

In the high-frequency filter of the present invention, preferably, both the input conductor and the output conductor have an open end, and the open end of the input conductor and the open end of the output conductor are provided on the same side with respect to the center magnetic field generated in the dielectric resonator when a high-frequency signal is input to the input conductor. With such an arrangement, a desired resonance frequency, including fine adjustment, can be easily obtained.

### BRIEF DESCRIPTION OF THE DRAWINGS

FIG. 1 is a perspective view showing an embodiment of a dielectric resonator 1 of a high-frequency filter according to the present invention;

FIG. 2 is a perspective view showing the relationship between the magnetic field of the dielectric resonator of FIG. 1 and a substrate;

FIG. 3 is a perspective view of the dielectric resonator of FIG. 1 when seen from a direction different from that of FIG. 2;

FIG. 4 is a perspective view showing an arrangement in which the dielectric resonator of FIG. 1 is mounted on the substrate;

FIG. 5 is a plan view of the dielectric resonator of FIG. 4;

FIG. 6 is a plan view showing a method of adjusting the coupling factor of the high-frequency filter according to the present invention;

FIG. 7 is a plan view showing another embodiment of a dielectric resonator according to the present invention;

FIG. 8 is a perspective view showing a conventional dielectric resonator;

FIG. 9 is a perspective view showing the relationship between the magnetic field of the dielectric resonator of FIG. 8 and a substrate; and

FIG. 10 is a perspective view showing the relationship between another conventional dielectric resonator and a substrate.

### DESCRIPTION OF THE PREFERRED EMBODIMENTS

The preferred embodiments of the present invention will now be described below with reference to the drawings.

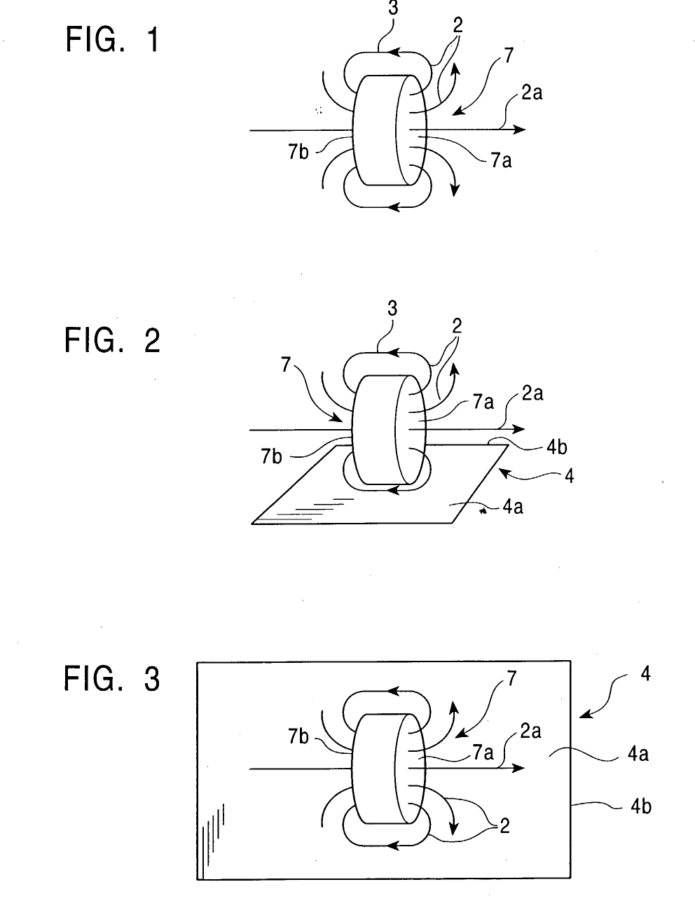

An embodiment of a dielectric resonator in a high-frequency filter of the present invention is shown in the perspective view of FIG. 1. An embodiment in a case where the dielectric resonator of FIG. 1 is brought in close proximity to a substrate is shown in the perspective view of FIG. 2. A perspective view of the dielectric resonator of FIG. 1 when seen from a direction different from that in FIG. 2 is shown in FIG. 3.

In FIG. 1, a dielectric resonator 7 according to the present invention has an overall shape of a cylindrical shape, a circular pillar shape, or a disc shape. The shape and the configuration (composition) of the dielectric resonator in the high-frequency filter of the present invention, which are basically the same as those of the above-described conventional dielectric resonator, can be used. That is, the dielectric resonator is made from a dielectric material having a high dielectric constant, and as the basic overall shape, a suitable shape, such as a cylindrical shape, a circular pillar shape, a disc shape, or a ring shape, can be selected.

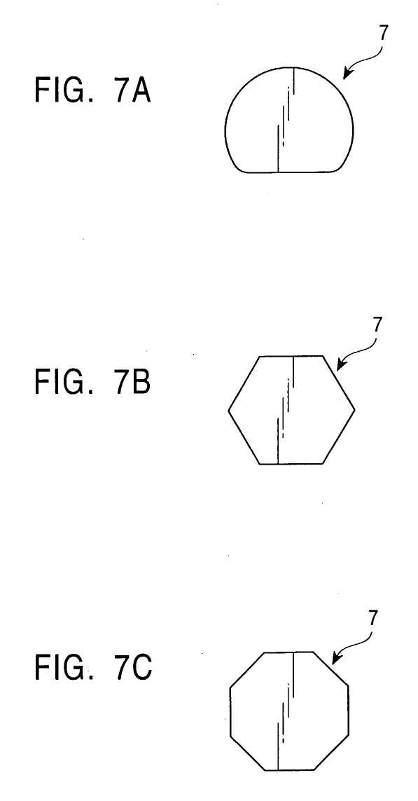

In FIG. 1, in the dielectric resonator 7, when an electric field 3 corresponding to the resonance frequency fc is applied, since this electric field 3 flows in a doughnut pattern or in a ring pattern in the circumferential direction inside the cylinder of a dielectric resonator 1a, similarly to the above-described conventional dielectric resonator 1 (FIG. 7), a high-frequency magnetic field indicated by “2” occurs, such as that which exists from a side circular surface 7a on the right side of the cylinder, circles around the cylinder, and returns to a side circular surface 7b on the left side of the cylinder. As will be described later, this high-frequency magnetic field 2 differs from that of the above-described conventional dielectric resonator 1 (FIG. 7) in that the direction of a center magnetic field 2a becomes approximately parallel to the substrate on which a conductor is formed.

At this time, the magnitude of the magnetic field of the dielectric resonator 7 is adjusted by the size of the dielectric resonator 7 and the dielectric constant of the dielectric material forming the dielectric resonator 7 so that the frequency becomes the resonance frequency fc corresponding to the wavelength λ of a high-frequency signal to be output. As will be described later, fine adjustment of the resonance frequency fc is performed by finely adjusting the position of the dielectric resonator 7.

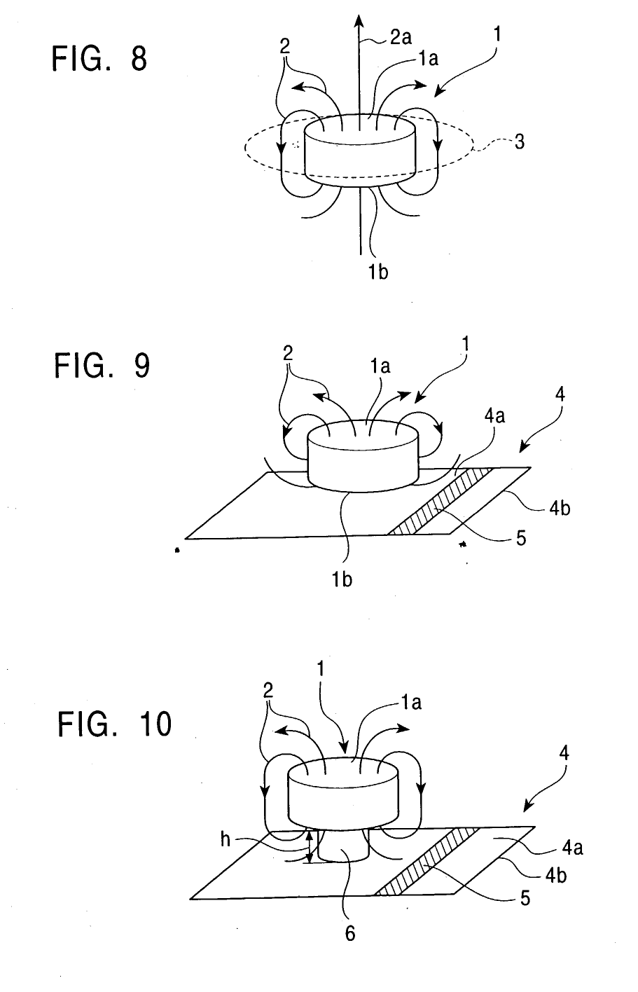

FIG. 2 shows an embodiment in which such a dielectric resonator is directly brought in close proximity to the surface of an insulating substrate on which a conductor (high-frequency strip line) is formed. In this case, similarly to the conventional dielectric resonator 1 (FIG. 8), a skin current flows on the surface of the substrate by being induced by the high-frequency magnetic field 2 of the dielectric resonator 7, and a skin effect occurs in which the high-frequency magnetic field on the substrate side, which occurs due to this electrical current, is generated in a direction in which the high-frequency magnetic field of the dielectric resonator is canceled. Due to this skin effect, similarly to the conventional dielectric resonator 1 (FIG. 8), the high-frequency magnetic field 2 on the lower side in contact with the substrate 4, which is the high-frequency magnetic field 2 of the dielectric resonator 7, is greatly distorted.

However, in FIG. 2, the dielectric resonator 7 is brought in close proximity to the surface of the substrate 4 so that the direction of the center magnetic field 2a of the dielectric resonator 7 becomes approximately parallel to the substrate. Therefore, the high-frequency magnetic field 2 above the center magnetic field 2a of the dielectric resonator 7 is less susceptible to the influence of the skin effect on the substrate side and is not likely to be distorted. As a result, since the variation of the resonance frequency fc of the high-frequency magnetic field 2 is decreased and the skin current induced in the substrate 4 is also decreased, a decrease of the effective Q of the high-frequency filter of the dielectric resonator 7 is drastically lessened.

Even when this is seen from FIG. 3, which is a perspective view of the dielectric resonator of FIG. 1, seen from a direction different from that of FIG. 2, it can be seen that the high-frequency magnetic field 2 above the center magnetic field 2a of the dielectric resonator 7 can freely flow through both sides of the dielectric resonator 7, is less susceptible to the influence of the skin effect on the substrate side, and is not likely to be distorted.

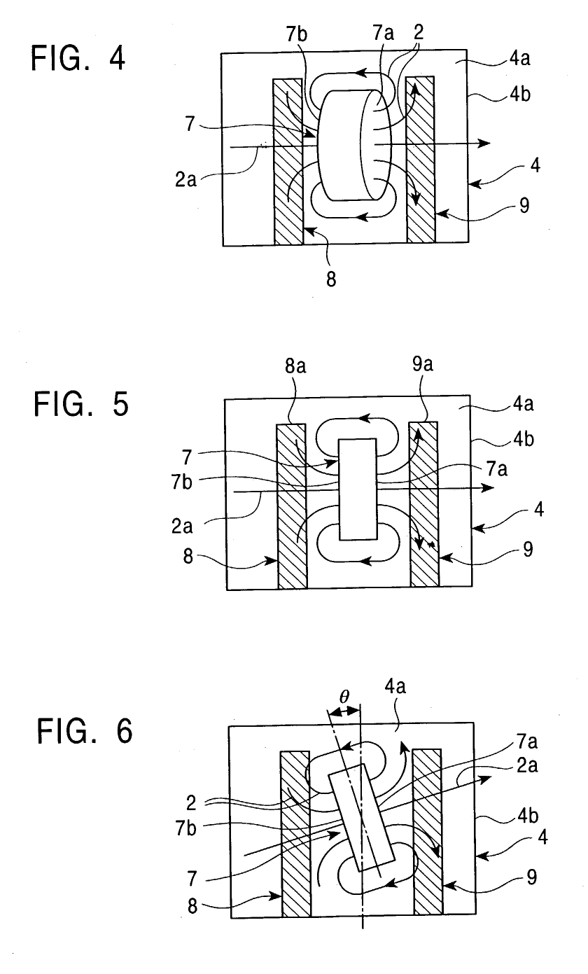

Next, as an embodiment of the high-frequency filter of the present invention, an embodiment in a case where the dielectric resonator of FIG. 1 is mounted on a substrate is shown in the perspective view of FIG. 4. A plan view of the dielectric resonator of FIG. 4 is shown in FIG. 5.

In FIGS. 4 and 5, an insulating substrate 4 is made from a dielectric (insulating material), such as a printed substrate or a ceramic substrate, in a manner similar to the substrate 4 of FIG. 8. The substrate 4 is configured in such a manner-that, basically, elongated high-frequency strip lines 8 and 9 for high-frequency transmission as conductors are provided on a surface 4a of the substrate, and a grounding conductor is provided on a rear surface 4b of the substrate. Here, the configuration is formed in such a manner that the entire rear surface of the substrate is a grounding conductor. The high-frequency strip line 8 serves as an input terminal for the dielectric resonator 7, and the high-frequency strip line 9 serves as an output terminal for the dielectric resonator 7.

The high-frequency strip lines 8 and 9 as conductors, the grounding conductor, etc., are made from a conductive material such that a conductive metal such as copper, aluminum, tin, gold, nickel, or solder, or another conductive material, is appropriately selected. Then, a conductor in which these conductive materials are used individually or in combination can be used as appropriate. For forming a high-frequency strip line, a grounding conductor, etc., on the surface of the substrate, well known methods, such as lamination, pasting, plating, printing, lithography of a foil base of these conductive materials can be applied.

The dielectric resonator 7 is mounted on the surface of the substrate 4 so that the direction of the center magnetic field 2a becomes approximately parallel to the substrate. That is, in order to be less susceptible to the influence of the skin effect on the substrate 4. side and in order not likely to be distorted, the dielectric resonator 7 is mounted on the surface of the substrate 4 so that a side circular surface 7a on the right side of the cylinder and a side circular surface 7b on the left side thereof, which are the two side surfaces of the dielectric resonator 7, become approximately perpendicular to the surface of the substrate 4. Furthermore, in FIGS. 4 and 5, the dielectric resonator 7 is mounted on the surface of the substrate 4 so that the side circular surface 7a on the right side of the cylinder and the side circular surface 7b on the left side thereof, which are the two side surfaces of the dielectric resonator 7, become approximately parallel to the extension direction of the high-frequency strip lines 8 and 9, in other words, the direction of the center magnetic field 2a becomes approximately perpendicular to the extension direction of the high-frequency strip lines 8 and 9.

The dielectric resonator 7 mounted on the surface of the substrate 4 is surrounded by a metal shield case (not shown), etc., and is shielded.

At this time, the bonding with the substrate 4 of the dielectric resonator 7 is possible by coating a bonding agent such as epoxy on the contact surface between the lower end portion (the peripheral surface of the cylinder) of the dielectric resonator 7 and the surface of the substrate 4. Even after the dielectric resonator 7 is mounted on the insulating substrate 4, the dielectric resonator 7 can also be loosely bonded to the insulating substrate 4 while maintaining a suitable bonding strength with the surface of the substrate 4 so that the dielectric resonator 7 is movable in the horizontal direction in order to adjust the positional relationship between the dielectric resonator 7 and the high-frequency strip lines 8 and 9, or so that the dielectric resonator 7 is rotatable in the horizontal direction in order to adjust an inclination angle (to be described later). Alternatively, a procedure is also possible in which the position and the angle at which the dielectric resonator 7 is placed are finely adjusted until the bonding agent is cured, and waiting for the bonding agent to be cured is performed at the position and the angle of the dielectric resonator 7, at which the desired resonance frequency and coupling factor are obtained, and the dielectric resonator 7 is fixed at that position and angle.

As regards to the shape of the dielectric resonator 7, as shown in FIGS. 7A, 7B, and 7C, if the portion (lower portion) in contact with the substrate of the dielectric resonator is formed flat, such as a cylindrical shape or a polygonal prism shape such as a hexagonal shape or an octagonal shape, in which the bottom of the dielectric resonator is flat, bonding with the substrate 4 and the adjustment of the positional relationship and the angle become easier. The adjustment of the coupling factor for the purpose of maintaining the effective Q to be high while the suppressing the loss of the high-frequency filter of the dielectric resonator, which will be described later, becomes easier.

For the position at which this dielectric resonator 7 is mounted, each point of the high-frequency strip lines 8 and 9, which is separated by a length of ¼ of the wavelength λ of the radio wave (high-frequency wave) from upper open ends 8a and 9a of the high-frequency strip lines 8 and 9, on the substrate at the resonance frequency fc, is considered, and the dielectric resonator 7 is bonded near the central portion of an imaginary line between the high-frequency strip lines which connect these two points. The position of the mounting of the dielectric resonator 7 is determined by the relationship with the wavelength λ of the high-frequency signal to be output from the high-frequency strip line 9.

In addition, the fine adjustment of the resonance frequency can be performed by moving finely the mounting position of the dielectric resonator 7 in a parallel direction in the extension direction of the high-frequency strip lines 8 and 9. In this manner, according to the configuration of the present invention, an additional member is not necessary for performing fine adjustment of the resonance frequency.

When there is a need to greatly change the resonance frequency, as described above, the change is performed by changing the dimension or the material of the dielectric resonator 7, that is, by replacing the dielectric resonator 7 itself. Even in this case, no change is required on the substrate side, and the change can be dealt with by only replacing the dielectric resonator 7. Therefore, by providing various dielectric resonators 7 while making the components on the substrate side common, it becomes possible to meet a variety of needs.

Here, a portion of the magnetic field 2 of the dielectric resonator 7 is coupled with the high-frequency strip lines 8 and 9. Therefore, the high-frequency signal input from the high-frequency strip line 8 is supplied to the dielectric resonator 7 via the magnetic field 2. At this time, since the dielectric resonator 7 resonates at only the supplied high-frequency signal, which is the same as the resonance frequency fc which is specific to the dielectric resonator 7, only the magnetic field of the resonance frequency fc is accentuated. As a result, only the magnetic field of the resonance frequency fc is coupled with the high-frequency strip line 9, and this is output as the selected high-frequency signal.

The strength of the coupling between the dielectric resonator 7 and the high-frequency strip lines 8 and 9 is mainly determined by the distance between the dielectric resonator 7 and the high-frequency strip line 8 and the distance between the dielectric resonator 7 and the high-frequency strip line 9.

However, in the configuration of the high-frequency filter of the present invention, since the dielectric resonator 7 is positioned between the high-frequency strip lines 8 and 9, for adjusting the strength of the coupling between the dielectric resonator 7 and the high-frequency strip line 8 and the strength of the coupling between the dielectric resonator 7 and the high-frequency strip line 9 at the same time, as will be described later, a method of adjusting the strength of the coupling by varying the angle of the dielectric resonator 7 is preferably used.

According to the above embodiment, it is possible to prevent a decrease of the effective Q of the dielectric resonator when this is mounted on the substrate, and possible to maintain the effective Q to be high. As a result, by using the magnetic field of the dielectric resonator 7, only the high-frequency signal of specific wavelength components to be output, of the high-frequency signal input from the high-frequency strip line 8, can be selectively output from the high-frequency strip line 9.

A method of adjusting the strength of the coupling between the dielectric resonator and the high-frequency strip line in the high-frequency filter of the present invention will now be described with reference to the plan view shown in FIG. 6.

In FIG. 6, the structure of the insulating substrate 4 and the dielectric resonator 7 is the same as that of FIGS. 4 and 5. The fact that the dielectric resonator 7 is placed on the surface of the substrate 4 so that the direction of the center magnetic field 2a becomes approximately parallel to the substrate is the same as that of FIGS. 4 and 5.

As shown in FIG. 6, the angle θ formed between the side circular surface 7a of the right side of the cylinder and the side circular surface 7b on the left side thereof, which are the two side surfaces of the dielectric resonator 7, and the direction in which the high-frequency strip lines 8 and 9 extend is varied by rotating the dielectric resonator 7 with the straight line which passes through the center of the dielectric resonator 7 and which is perpendicular to the surface of the substrate being the axis. By adjusting the angle θ, the strength of the coupling between the dielectric resonator 7 and the high-frequency strip lines 8 and 9 can be adjusted.

When this angle θ is 0, as in the embodiment of FIGS. 4 and 5, the direction of the center magnetic field 2a becomes approximately at right angles to the extension direction of the high-frequency strip lines 8 and 9, and the strength of the coupling between the dielectric resonator 7 and the high-frequency strip lines 8 and 9 becomes a maximum. When this angle θ is increased, the direction of the center magnetic field 2a deviates from approximately the right angles to the extension direction of the high-frequency strip lines 8 and 9, and the coupling factor is decreased. Then, when this angle θ becomes 90 degrees, the direction of the center magnetic field 2a becomes approximately parallel to the extension direction of the high-frequency strip lines 8 and 9, and the coupling factor becomes 0.

In this case, even if the inclination angle θ of the dielectric resonator 7 is varied, the effective Q of the dielectric resonator 7 hardly changes. Therefore, the present invention has the advantage that only the coupling factor between the dielectric resonator 7 and the insulating substrate 4 can be easily adjusted without decreasing the effective Q of the dielectric resonator 7 by arranging the dielectric resonator 7 so that the direction of the center magnetic field becomes approximately parallel to the insulating substrate 4.

On the insulating substrate 4, usually, in addition to the high-frequency strip lines 8 and 9, a conductor portion exists. Such a conductor which is not related to the input/output of the high-frequency filter becomes a load for the dielectric resonator 7 when the conductor is coupled with the dielectric resonator 7 by a magnetic field. This causes the effective Q to be drastically decreased. As described above, coupling between the dielectric resonator 7 and the conductor portion other than the high-frequency strip lines 8 and 9 becomes extra coupling. The adjustment of the coupling factor between the dielectric resonator 7 and the insulating substrate 4 without decreasing the effective Q of the dielectric resonator 7 means that the coupling factor between the dielectric resonator 7 and the high-frequency strip lines 8 and 9 is adjusted while minimizing that extra coupling. As a result of arranging the dielectric resonator 7 so that the direction of the center magnetic field of the dielectric resonator 7 becomes approximately parallel to the insulating substrate 4, that extra coupling can be minimized.

The adjustment in which the dielectric resonator 7 is moved in a parallel direction in the extension direction of the high-frequency strip lines 8 and 9 mainly allows the resonance frequency to be adjusted. The adjustment of the angle θ of the dielectric resonator 7 with respect to the extension direction of the high-frequency strip lines 8 and 9 mainly allows the strength of the coupling factor to be adjusted. Therefore, by adjusting the position and the angle at which the dielectric resonator 7 is mounted, both the resonance frequency and the strength of the coupling can be adjusted easily and effectively. Moreover, in that adjustment, the effective Q is always maintained at a sufficiently high level. As described above, the advantages of the high-frequency filter of the present invention are that the adjustment of the resonance frequency and the strength of the coupling can be easily realized without adding an adjustment member without decreasing the effective Q.

The adjustment of the angle θ needs to be performed in a range in which resonance occurs in only the mode which should primarily occur, that is, in a range in which the resonance of the mode other than the mode which should primarily occur can be ignored. In general, it is considered that the angle θ may be adjusted in a range of −30 degrees to +30 degrees.

When the coupling factor between the dielectric resonator 7 and the substrate 4 is to be adjusted by varying the inclination angle θ of the dielectric resonator 7, the dielectric resonator 7 may be placed or temporarily locked on the substrate 4 in advance, and in due time, the coupling factor is adjusted by varying the inclination angle θ of the dielectric resonator 7, after which the dielectric resonator 7 can be bonded and fixed thereto. Also, after the dielectric resonator 7 is mounted on the insulating substrate 4, in order to adjust the inclination angle θ of the dielectric resonator 7 while the high-frequency filter is being used, the dielectric resonator 7 can also be bonded to the insulating substrate 4 in such a manner as to be rotatable in the horizontal direction.

In the above-described embodiment, although the dielectric resonator 7 is directly bonded to the insulating substrate 4, the present invention is not limited to this embodiment. In order to obtain necessary characteristics or for the convenience of manufacture, the dielectric resonator 7 may be mounted on the insulating substrate 4 via a member, and a hole may be provided in the insulating substrate 4 so that the dielectric resonator 7 is fitted into that hole.

In the above-described embodiments, a case in which the dielectric resonator is used as a dielectric resonator itself has been described. In the present invention, in a high-frequency filter, a dielectric resonator with the same configuration can also be used as an oscillator. More specifically, for the dielectric resonator, a dielectric oscillator is used, and by varying the mounting angle of the dielectric oscillator corresponding to the high-frequency strip line with respect to an amplifying element, the coupling factor between the dielectric oscillator and the amplifying element can be adjusted. For this reason, the amount of feedback via the dielectric oscillator can be finely adjusted, and the oscillation level can also be finely adjusted. Thus, adjustment is possible so that phase noise is minimized. As a result, an oscillator having an externally low phase noise can be realized.

What is claimed is:

1. A high-frequency filter comprising:
an insulating substrate;
a linear input conductor formed on the surface of said insulating substrate;
a linear output conductor formed substantially in parallel to said input conductor on the same surface of said input conductor of said insulating substrate; and
a dielectric resonator which is coupled to said insulating substrate, said dielectric resonator being provided between said input conductor and said output conductor with respect to a direction perpendicular to the extension direction of said input conductor and said output conductor,
wherein said dielectric resonator is arranged so that the direction of the center magnetic field generated in said dielectric resonator when a high-frequency signal is input to said input conductor becomes substantially parallel to said insulating substrate and becomes approximately at right angles to the extension direction of said input conductor and said output conductor.

2. The high-frequency filter according to claim 1, wherein said dielectric resonator has a shape selected from a cylindrical shape, a circular pillar shape, a disc shape, a ring shape, and a polygonal prism shape.

3. The high-frequency filter according to claim 1, wherein said dielectric resonator is directly bonded to said insulating substrate.

4. The high-frequency filter according to claim 3, wherein a portion of said dielectric resonator that is in contact with said insulating substrate is flat.

5. The high-frequency filter according to claim 1, wherein a grounding conductor is arranged on the surface of said insulating substrate, which is opposite to the surface on which said input conductor and said output conductor are provided.

6. The high-frequency filter according to claim 1, wherein both said input conductor and said output conductor have an open end, and the open end of said input conductor and the open end of said output conductor are provided on the same side with respect to the center magnetic field generated in said dielectric resonator when a high-frequency signal is input to said input conductor.
